(19) United States
(12) Patent Application Publication
(10) Pub. No.: US 2009/0286089 A1
(43) Pub. Date: Nov. 19, 2009

(54) ACRYLIC-BASED ADHESIVES FOR POLYVINYLIDENE SURFACES

(75) Inventors: Alex Toback, Bloomfield, CT (US); Paul Chaplinsky, Southington, CT (US); Charles Schuft, Boxborough, MA (US); Ifeanyi Chris Broderick, East Hampton, CT (US); James Murray, Newmarket, NH (US); Douglas E. Frost, Kingston, NH (US)

Correspondence Address: Loctite Corporation, One Henkel Way, Rocky Hill, CT, 06067, US

(73) Assignee: Henkel Corporation, Rocky Hill, CT (US)

(21) Appl. No.: 12/302,388

(22) PCT Filed: Jun. 4, 2007
(86) PCT No.: PCT/US07/13111

§ 371 Date: Nov. 25, 2008

Related U.S. Application Data
(60) Provisional application No. 60/810,973, filed on Jun. 5, 2006.

(51) Int. Cl. B32B 27/08; C08L 33/12; B32B 37/12; B05D 3/02

(52) U.S. Cl. 428/421; 525/308; 156/327; 156/333; 427/385.5

(57) ABSTRACT

A process for improving adhesion to a surface that is at least partially coated with a fluorocarbon-containing coating, as well as a method for bonding surfaces that are at least partially coated with a fluorocarbon-containing coating, are disclosed. Moreover, compositions that may be used in the aforementioned process and method are disclosed. Additionally, articles and assemblies that include surfaces that are coated with a fluorocarbon-containing coating are disclosed.

### FIELD OF THE INVENTION

The present invention relates generally to a process for improving adhesion to a surface that is at least partially coated with a fluorocarbon-containing coating, as well as to a method for bonding surfaces that are at least partially coated with a fluorocarbon-containing coating. Moreover, the present invention relates to compositions for use in the aforementioned process and method. Additionally, the present invention relates to articles and assemblies that include fluorocarbon-coated surfaces.

### BRIEF DESCRIPTION OF RELATED TECHNOLOGY

Surfaces that are coated with a fluorocarbon-containing coating are routinely utilized in a variety of industries, including the construction, vehicle, and appliance industries. In particular, metal surfaces that are coated with zinc-containing compositions or zinc alloy-containing compositions (e.g., Galfan® and Galvalume®) are often coated with a polyvinylidene fluoride-containing paint and utilized in applications such as light gauge steel construction and metal roofing systems (particularly, as roof panels).

However, it has hitherto been difficult to bond structural adhesives to surfaces that are coated with a fluorocarbon-containing coating and, more particularly, surfaces that are coated with a polyvinylidene fluoride-containing coating. Indeed, conventional adhesive compositions demonstrate poor adhesion to polyvinylidene fluoride-coated galvanized surfaces at room temperature, thereby making it difficult to bond such surfaces together.

Consequently, polyvinylidene fluoride-coated galvanized surfaces have traditionally been joined together by welding or mechanical fixing means (e.g., screws, rivets, and lock-forming means). Joining surfaces by welding or mechanical fixing means, however, is labor-intensive and expensive, and does not provide the advantages attendant use of adhesive compositions (e.g., weight-saving advantages, ease and rapidity of preparation, and cost-effectiveness).

Thus, it would be desirable to provide a process for improving adhesion to a surface that is coated with a polyvinylidene fluoride-containing coating, as well as a method for bonding surfaces that are coated with a polyvinylidene fluoride-containing coating.

### BRIEF DESCRIPTION OF THE DRAWINGS

FIG. 1 is a side view of an article of manufacture including two polyvinylidene fluoride-coated substrate surfaces that are bonded together with a composition of the present invention.

FIG. 2 is a side view of an assembly of the present invention.

### SUMMARY OF THE INVENTION

In one aspect of the invention, there is provided a method for bonding together two substrates, including the steps of: (a) applying to a first substrate surface a composition including: (i) at least one curable (meth)acrylate component; (ii) at least one elastomeric polymer that is soluble in the (meth)acrylate component; and (iii) an organic acid component; (b) mating the surface of a second substrate in abutting relationship with composition-applied first substrate surface to form an assembly; and (c) maintaining in place the abutting relationship for a time sufficient to allow the composition to cure, where at least one of the abutting substrate surfaces is at least partially coated with a fluorocarbon-containing coating, and where an adhesive bond is formed between the composition and the fluorocarbon-containing coating.

In another aspect of the invention, there is provided a process for improving adhesion to a substrate surface that is partially or completely coated with a fluorocarbon-containing coating, including the steps of: 1.) applying to a substrate surface that is partially or completely coated with a fluorocarbon-containing coating an adhesive composition, where the composition includes: (i) at least one curable (meth)acrylate component; (ii) at least one elastomeric polymer that is soluble in the (meth)acrylate component; and (iii) an organic acid component; and 2.) subjecting the composition-applied substrate surface to conditions sufficient to allow the composition to cure, where an adhesive bond is formed between the composition and the fluorocarbon-containing coating.

In yet another aspect of the invention, there is provided an assembly including: (a) an adhesive system including a composition including: (i) at least one curable (meth)acrylate component; (ii) at least one elastomeric polymer that is soluble in the (meth)acrylate component; and (iii) an organic acid component; and (b) at least one substrate surface that is partially or completely coated with a polyvinylidene fluoride-containing coating, where the composition bonds to the polyvinylidene fluoride-containing coating.

In still another aspect of the invention, there is provided a composition including: (i) a first part including (a) at least one (meth)acrylate component in an amount that is from about 30% by weight to about 95% by weight of the first part; (b) at least one elastomeric polymer in an amount that is from about 10% by weight to about 30% by weight of the first part; and (c) at least one organic acid component in an amount that is from about 1% by weight to about 5% by weight of the first part; and (ii) a second part including (a) at least one (meth)acrylate component in an amount that is from about 60% by weight to about 99% by weight of the second part; (b) at least one component that functions as a corrosion inhibitor and/or UV stabilizer in an amount that is from about 10% to about 30% by weight of the second part; and (c) at least one accelerator component in an amount that is from about 1% by weight to about 5% by weight of the second part.

In yet another aspect of the invention, there is provided a composition for bonding two substrates including: (a) a first part including: (i) at least one alkyl (meth)acrylate; (ii) a polyethylene-based rubber; and (iii) at least one hydroxyalkyl (meth)acrylate; and (b) a second part including: (i) at least one alkyl (meth)acrylate; and (ii) an accelerator.

### DETAILED DESCRIPTION OF THE INVENTION

The present invention is directed to compositions for improving adhesion to a surface that is at least partially coated with a polyvinylidene fluoride-containing coating, and to methods of using such compositions to bond together surfaces that are at least partially coated with a polyvinylidene fluoride-containing coating. Moreover, the present invention is directed to articles and assemblies that include polyvinylidene fluoride-coated surfaces.

The compositions of the present invention may include two parts, i.e., a first part and a second part. In particular, the compositions may be formulated to include (i) a first part that includes at least one curable (meth)acrylate component in combination with at least one elastomeric polymer and at least one organic acid component and (ii) a second part that includes at least one (meth)acrylate component in combination with an accelerator. As used herein, the term “(meth)acrylate” refers to both acrylate and methacrylate components. Useful (meth)acrylate components may be chosen from a wide variety of materials represented by the following formula;

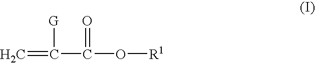

where G may be hydrogen, halogen or alkyl of 1 to about 4 carbon atoms, and R¹ may be selected from alkyl, cycloalkyl, alkenyl, cycloalkenyl, alkaryl, aralkyl or aryl groups of 1 to about 16 carbon atoms, any of which may be optionally substituted or interrupted as the case may be with silane, silicon, oxygen, halogen, carbonyl, hydroxyl, ester, carboxylic acid, urea, urethane, carbamate, amine, amide, sulfur, sulfonate, sulfone, and the like. When G is hydrogen, the (meth)acrylate component corresponding to the above formula is an acrylate component. Moreover, when G is methyl, the (meth)acrylate component corresponding to tie above formula is a methacrylate component.

Additionally, useful (meth)acrylate components may be chosen from the alkylene glycol diacrylates having the general formula:

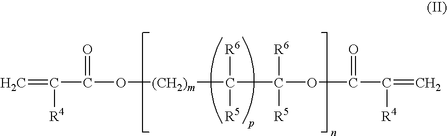

wherein R₄ is selected from hydrogen, halogen, and lower alkyl of 1-4 carbon atoms; R₅ is selected from hydrogen, —OH,

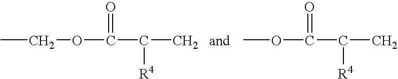

R₆ is selected from hydrogen, lower alkyl of 1-4 carbon atoms, hydroxyalkyl of 1-4 carbon atoms, and m is an integer equal to at least 1, desirably 1-8 and more desirably from 1 to 4; n is an integer equal to at least 1, desirably, 1 to 20; and p is 0 or 1. When R⁴ is hydrogen, the (meth)acrylate component corresponding to the above formula is an acrylate component. Moreover, when R⁴ is methyl, the (meth)acrylate component corresponding to the above formula is a methacrylate component.

Typical of these monomers are mono-, di-, tri-, tetra-, and polyethylene glycol dimethacrylate and the corresponding diacrylates; di(pentamethylene glycol) dimethacrylate; tetraethylene glycol di(chloroacrylate); diglycerol diacrylate; diglycerol tetramethacrylate; and butylene glycol dimethacrylate. Useful monomers also include neopentylglycol diacrylate and trimethylolpropane triacrylate.

Particularly useful polymerizable crosslinkable components that may be used as the (meth)acrylate component are ethoxylated trimethylolpropane triacrylate, trimethylol propane trimethacrylate, dipentaerythritol monohydroxypentacrylate, pentaerythritol triacrylate, 1,6-hexanedioldiacrylate, neopentyl glycoldiacrylate, pentaerythritol tetraacrylate, 1,2-butylene glycoldiacrylate, trimethylopropane ethoxylate tri(meth)acrylate, glyceryl propoxylate tri(meth)acrylate, trimethylolpropane tri(meth)acrylate, dipentaerythritol monohydroxy penta(meth)acrylate, tritpropylene glycol) di(meth)acrylate, neopentylglycol propoxylate di(meth)acrylate, 1,4-butanediol di(meth)acrylate, polyethyleneglycol di(meth)acrylate, triethyleneglycol di(meth)acrylate, butylene glycol di(meth)acrylate, ethoxylated bisphenol A di(meth)acrylate, and combinations thereof.

Various useful urethane-acrylate monomers, such as those described in U.S. Pat. No. 3,425,988 to Gorman, and U.S. Pat. No. 4,309,526 to Baccei, each of which is incorporated herein by reference, also may be used as the (meth)acrylate component. The monomers disclosed in the '526 patent may be viewed as one-component, polymerizable block copolymers (prepolymers) having rigid and flexible segments. This is achieved by the chemical linking of precursor “prepolymers” which are subsequently “capped” with (meth)acrylate functionality.

Moreover, acrylates derived from bisphenol-A, such as bisphenol-A dimethacrylate, hydrogenated bisphenol-A dimethacrylate, and ethoxylated bisphenol-A dimethacrylate also may be used as the (meth)acrylate component.

Furthermore, although di- and other polyacrylate esters have been found particularly desirable, monofunctional acrylate esters (esters containing one acrylate group) also may be used as the (meth)acrylate component. When dealing with monofunctional acrylate esters, it is desirable to use an ester which has a relatively polar alcoholic moiety. Such materials are less volatile than low molecular weight alkyl esters and, more importantly, the polar group tends to provide intermolecular attraction during and after cure, thus producing more desirable cure properties, as well as a more durable sealant or adhesive. Particularly desirable are the polar groups selected from labile hydrogen, heterocyclic ring, hydroxy, amino, cyano, and halogen polar groups. Useful examples of compounds within this category include cyclohexyl methacrylate, tetrahydrofurfuryl methacrylate, hydroxyethyl acrylate, hydroxypropyl methacrylate, t-butylaminoethyl methacrylate, cyanoethylacrylate, and chloroethyl methacrylate. The materials are often incorporated as reactive diluents which are capable of copolymerizing with the various other polymerizable materials. Other unsaturated reactive diluents, such as styrene and acrylonitrile, also may be used.

Desirably, the first part of a composition of the present invention includes at least three (meth)acrylate components, while the second part desirably includes at least one (meth)acrylate component. In particular, the first part of a composition of the present invention desirably includes methyl methacrylate, at least one hydroxyalkyl methacrylate component, and at least one methacrylate ester component. Moreover, the second part of a composition of the present invention also desirably includes methyl methacrylate.

Suitable hydroxyalkyl methacrylate components include, for example, hydroxymethyl methacrylate, hydroxypropyl methacrylate, hydroxybutyl methacrylate, and MHORMER® BM-905 (hydroxyethyl methacrylate monomer (HEMA). Desirably, a hydroxyalkyl methacrylate component is included in the first part of a composition of the present invention in an amount that is from about 10% by weight to about 30% by weight of the first part.

It is particularly useful to incorporate a methacrylate ester in the first part of a composition of the present invention in an amount that is from about 1% by weight to about 5% by weight of the first pall.

Desirably, methyl methacrylate is incorporated in the first part of a composition of the present invention in an amount that is from about 30% by weight to about 60% by weight of the first part. Moreover, methyl methacrylate is desirably incorporated in a second part of a composition of the present invention in an amount that is from about 60% by weight to about 99% by weight of the second part.

Any suitable elastomeric polymer may be used in the compositions of the present invention, including those elastomeric polymers known in the art to be soluble in a resin such as a (meth)acrylate monomer. Desirably, the elastomeric polymer functions as a toughening component. In particular, a wide variety of elastomeric materials that form discrete particles or biphasic domains in a continuous resin matrix may function as toughening components in the present invention. For example, prereacted particles of polyacrylate, styrene/butadiene/styrene (SBS) copolymers, styrene/isoprene/styrene (SIS) copolymers, styrenelbutadiene (SBR) copolymers, as well as other prereacted materials may be added in particulate form to the resin composition. A partial listing of useful prereacted elastomer rubbers includes prereacted elastomer particles selected from the group consisting of acrylate-butadiene, butadiene, chloroprene, ethylene-propylene, ethylene-propylene-diene, isoprene, isobutylene, isobutylene-isoprene (butyl rubber), styrene-butadiene, styrene-isoprene, acrylonitrile-butadiene, acrylonitrile-chloroprene, vinylpyridine-butadiene, vinylpyridine-styrene-butadiene, carboxylic-styrene-butadiene, chloroisobutylene-isoprene (chlorobutyl rubber), bromoisobutylene-isoprene (bromobutyl rubber), dialkylsiloxane, poly(propylene oxide), polyesterurethancs, polyetherurethanes, and mixtures thereof.

Moreover, reactive liquid polymers (RLP's) also may be incorporated as a toughening component. RLP's contain functional groups, usually on their terminal ends but occasionally as pendant groups, and react with the resin in situ to form elastomeric domains. Examples of RLP's include, without limitation, carboxy-terminated butadiene nitrite (CTBN), amine-terminated butadiene nitrite (ATBN), hydroxy-terminated butadiene nitrite (HTBN), epoxy-terminated butadiene nitrite (ETBN), mercapto-terminated butadiene nitrite (MTPN), and phenoxy-terminated butadiene nitrite (PTBN).

Particularly useful agents that may be utilized as a toughening component include, for example, BLENDEX® 338, nitrite rubber (such as those listed above), and chlorosulfonated polyethylenes represented by the structure:

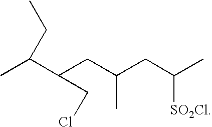

Particularly useful chlorosulfonated polyethylenes include, for example, HYPALON® 20 chlorosulfonated polyethylene and HYPALON® 30 chlorosulfonated polyethylene.

Desirably, an elastomer is incorporated in the first part of a composition of the present invention in an amount that is from about 10% by weight to about 30% by weight of the first part of the composition. It is particularly useful to incorporate a polyethylene-based rubber in the first part of a composition of the present invention in an amount that is from about 10% by weight to about 30% by weight of the first part.

Any suitable organic acid component may be incorporated in the compositions of the present invention in any suitable amount. Suitable organic acids include, for example, carboxylic acids. Suitable carboxylic acids include, for example, methacrylic acid, maleic acid, acrylic acid, fumeric acid, and acid derivatives of acrylic and methacrylic acid, such as beta carboxy ethyl acrylic acid (BCEA), succinic acid and other carboxylic acids and derivatives thereof that would be known to one of ordinary skill in the art.

Desirably, an organic acid component is incorporated in the first part of a composition of the present invention in an amount that is from about 1% by weight to about 5% by weight of the first part. It is particularly useful to incorporate methacrylic acid in the first part of a composition of the present invention in an amount that is from about 1% by weight to about 5% by weight of the first part.

Any suitable polymer stabilizer may be incorporated in the compositions of the present invention in any suitable amount. Desirably, a polymer stabilizer is incorporated in the first part of a composition of the present invention in an amount that is from about 1% by weight to about 5% by weight of the first part.

Useful polymer stabilizers include, for example, hydroquinone (HQ), nanoquinone (NQ), and methyl ethyl hydroquinone (4-methoxyphenol). A particularly useful polymer stabilizer for incorporation in the compositions of the present invention is 2,6-di-t-butyl-p-cresol (butylated hydroxy toluene (BHT)). Desirably, 2,6-di-t-butyl-p-cresol is incorporated in the first part of a composition of the present invention in an amount that is from about 1% by weight to about 5% by weight of the first part.

Any suitable antioxidant may be included in the compositions of the present invention in any suitable amount. Particularly useful antioxidants include, for example, phenolic antioxidants such as those available commercially from Crompton Corporation under the tradename NAUGARD®, butylated hydroxy toluene (BHT), and hydroquinone.

In some embodiments, the antioxidant also may function as a stabilizer. A particularly useful antioxidant that also functions as a stabilizer is 4-methoxyphenol.

Desirably, an antioxidant is incorporated in the first part of a composition of the present invention in an amount that is from about 1% by weight to about 5% by weight of the first part. It is particularly useful to incorporate 4-methoxyphenol in the first part of a composition of the present invention in an amount that is from about 1% by weight to about 5% by weight of the first part.

Any suitable filler may be included in the compositions of the present invention in any suitable amount. Suitable fillers include, for example, nephyline syenite, alkali metal carbonates, silicas, talc, and soda lime borosilicate glass.

Desirably, at least one filler is included in the first part of a composition of the present invention in an amount that is from about 0.1% by weight to about 2% by weight of the first part of the composition. It is particularly useful to include talc in the first part of a composition of the present invention in an amount that is from about 0.1% by weight to about 1% by weight of the first part of the composition. Moreover, it is particularly useful to include soda lime borosilicate glass in the first part of a composition of the present invention in an amount that is from about 0.1% by weight to about 1% by weight of the first part.

Any suitable corrosion inhibitor may be incorporated in the compositions of the present invention in any suitable amount. Suitable commercially available corrosion inhibitors include, for example, phosphate complexes, metal phosphosilicates, alkali metal phosphosilicates, alkaline-earth metal phosphosilicates, sulfonates, alkanoates, and metal salts thereof, silico phosphates, benzoates, vapor phase corrosion inhibitors, zinc-containing powders, phenols such as hydroquinone and quinones, metaborates, metal metaborates, succinates, sulfur-based vapor phase corrosion inhibitors, metal (such as zinc, calcium, or magnesium, etc), salts of aromatic sulfonic acids (e.g. dinonyl naphthalene sulfonic acid-zinc salt), silazanes, metal carbonates, and combinations thereof.

More particularly, suitable corrosion inhibitors include the following: HALOX® CZ-170 (enhanced zinc ortho phosphate complex) and HALOX® Z-PLEX 111 (phosphosilicate, zinc phosphate complex) (sold by Halox Pigments, Hammond, Ind.); SACI®) 760 (dispersion of modified calcium sulfonate in mineral spirits) (sold by Stoney Creek Technologies, LLC, Trainer, Pa.); COTROL® 18-8 (dialkylamino alkanoate, metal salt), COTROL® 316-FG (free flowing powder, based on calcium silico phosphate), COTROL® AMB (ammonium benzoate), COTROL®D BMB (barium metaborate) (sold by CasChem, Inc., Bayonne, New Jersey, by Buckman Labs, Memphis, Tenn., and by TryLine Co, Seattle, Wash.); any suitable vapor phase corrosion inhibitor (sold by Cortec Corporation, St. Paul, Minn.); and combinations thereof.

Particularly useful inhibitors include HALOX® SZP-391 (strontium zinc phosphosilicate) and HALOX® CW-491 (calcium phosphosilicate) (sold by Halox Pigments, Hammond, Ind.), zinc OMADINE® powder (zinc pyrithione, zinc pryridinethione) (sold by Arch Chemicals, Dublin, Ireland); S-hydroxy quinoline (sold by TCI-America, Portland, Oreg.), COTROL® BMB (barium metaborate) (sold by CasChem, Inc., Bayonne, N.J.), IRGACOR® 252 LD (benzothiazole succinate) (sold by Vantico, Brewster, N.Y.), M-5365 (sulfur-based vapor phase corrosion inhibitor) (sold by Cortec Corporation, St, Paul, Minn.), NACORR® 1552 (dinonyl naphthalene sulfonic acid-zinc salt supplied in 2-butoxy ethanol) (sold by King Industries, Science Rd., Norwalk, Conn.), KION® S (proprietary silazane polymer) (sold by Kion Corp., Pioneer Rd., Huntington Valley, Pa.), and zinc carbonate (sold by Aldrich, PO Box 355, Milwaukee, Wis.); the salts of boric acid, such as the barium salt of boric acid; and combinations thereof. A particularly useful combination of corrosion inhibitors is zinc OMADINE® powder in combination with IRGACOR® 252 LD and 8-hydroxy quinoline.

In some embodiments, the corrosion inhibitor also functions as a UV stabilizer. A particularly useful corrosion inhibitor that also functions as a UV stabilizer is the barium salt of boric acid.

Desirably, a component that functions as a corrosion inhibitor and/or UV stabilizer is incorporated in the second part of a composition of the present invention in an amount that is from about 10% by weight to about 30% by weight of the second pail. It is particularly useful to incorporate the barium salt of boric acid in the second part of a composition of the present invention in an amount that is from about 10% by weight to about 30% by weight of the second part.

Various accelerator compounds, such as tertiary amines, imides, polyamines, cyclicamines, and arylamines may be included in the compositions of the present invention to increase cure speeds and completion of cure. See, e.g., U.S. Pat. No. 3,041,322 (tertiary amines), U.S. Pat. No. 3,046,262 (imides), U.S. Pat. No. 3,203,941 (polyamines), U.S. Pat. No. 3,218,305 (cyclic and arylamines), all of which are to Kriebel et al., and U.S. Pat. No. 3,591,438, to Toback et al., the disclosures of which are all incorporated herein by reference. Other potential accelerators include, without limitation, strong acids, organic and inorganic acids, fluoro acids, fluoro-sulphonic acids, fluoro acetic acids, water, phenols, fluoro-phenols, salicylic acid, amines, calcium, and metal salts of any or all the acids above, polyols, active hydrogen materials and their salts and/or complexes, and the like.

Other useful accelerators for the present invention include compounds having the following formula:

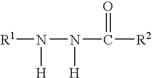

where R¹ is selected from alkyl from 2 to 6 carbon atoms, cycloalkyl, aryl, alkenyl, and cycloalkenyl and R² is selected from hydrogen, alkyl cycloalkyl, alkenyl and cycloalkenyl, aryl, alkoxy, aryloxy, carbonyl, amino, and the following groups:

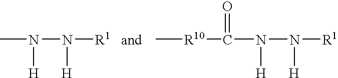

where R¹⁰ is selected from alkyl groups containing one to about 10 carbon atoms, alkenyl groups containing two to about 10 carbon atoms, and aryl groups containing up to about 10 carbon atoms. Examples of useful accelerator compounds include 1-acetyl-2-phenyl hydrazine, 1-acetyl-2(p-tolyl) para-toluene sulfonyl hydrazide, 1-formyl-2-phenyl hydrazine, and combinations thereof.

Other useful accelerators that may be incorporated in the compositions of the present invention include pyridine derivatives having the formula:

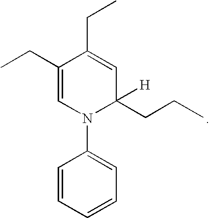

One particularly useful pyridine derivative is phenyl dihydropyridine (PDHP), which is sold under the tradename REILLYCAT® ASY-2.

Suitable accelerators also include transition metals, such as copper, cobalt, magnesium, vanadium, manganese, iron, and salts and complexes thereof, saccharin, and alkylated aromatic amines, such as dimethyl p-toluidine (DMPT), and derivatives of alkylated aromatic amines. Metal salt solutions such as copper salt solutions are particularly useful. More particularly, acetyl acetone metal complexes such as 2,4-pentane dione/copper complexes and naphthenate/copper complexes are useful. For example, copper naphthenate in methyl methacrylate may be included in the present inventive compositions. A particularly useful accelerator for use in the compositions of the present invention is an aldehyde-amine condensate.

The accelerator may be incorporated in the compositions of the present invention in any suitable amount. Desirably, an accelerator is incorporated in the second pail of a composition of the present invention in an amount that is from about 1% by weight to about 5% by weight of the second part. It is particularly useful to include an aldehyde-amine condensate in the second part of a composition of the present invention in an amount that is from about 1% by weight to about 5% by weight of the second part.

A number of well-known initiators of free radical polymerization also may be incorporated in the compositions of the present invention. Peroxides and peresters are particularly useful. For example, suitable initiators of free radical polymerization include, without limitation, cumene hydroperoxide (CHP), paramenthane hydroperoxide, tertiary butyl hydroperoxide (TBH), tertiary butyl perbenzoate (TBPB), and benzoyl peroxide (BPO). The useful amounts of free-radical initiator component typically range from about 0.5% by weight to about 3% by weight of the total composition. As used herein, the phrase total composition refers to a composition having a first pail and a second part.

In some embodiments, it may be useful to include a phosphate ester in the compositions of the present invention. Suitable phosphate esters for use in the composition of the present invention include those represented by the formula:

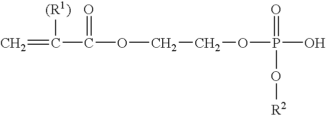

where R¹ is H or CH₃, and R² is H, and where R² can additionally include:

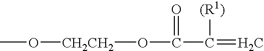

where R¹ is H or CH₃. A particularly useful phosphate ester for use in the present invention is HEMA phosphate ester, which is sold under the tradename T-MULZ® 1228.

Any suitable carrier component may be used in the compositions of the present invention. The primary purpose of the carrier component is to serve as a vehicle for other components such as the accelerator component. Suitable carrier components include, for example, reactive resins and non-reactive resins. Desirably, the resin is reactive and is a (meth)acrylate resin.

Chelating agents also may be employed to control and prevent premature peroxide decomposition and polymerization, as well as to remove trace amounts of metal contaminants. A particularly useful chelating agent is the tetrasodium salt of ethylenediamine tetraacetic acid (FDTA). Useful amounts of a chelating agent typically range from about 0.01% by weight to about 2% by weight of the total composition. Desirably, the chelating agent is present in an amount of from about 0.02% by weight to about 0.2% by weight of the total composition.

Any suitable thixotrope may be included in the compositions of the present invention. Suitable thixotropic agents include, for example, those available commercially from King Industries under the DISPARLON®W trade name, such as DISPARLON® 6100 and DISPARLON® 6200, organo clay, and polyamide powder. Useful amounts of thixotropes typically range from about 0% by weight to about 10% by weight of the total composition. Desirably, a thixotrope is present in an amount from about 0.5% to about 3% by weight of the total composition.

Any suitable blooming agent may be included in the compositions of the present invention. A suitable blooming agent is, for example, paraffin wax. Useful amounts of wax typically range from about 0.1% by weight to about 3% by weight of the total composition.

Other agents such as thickeners, plasticizers, thermoplastics, coloring agents, shelf-life extenders (for example, zinc chloride), industrial microbiostats (for example, zinc omadine powder), surfactants or wetting agents, polymerization inhibitors, viscosity modifiers, adhesion promoters, and other well-known additives also may be incorporated where functionally desirable. Moreover, spacer beads (such as 5 mil glass beads, or 30 mil glass beads, or 30 mil plastic particles, or inert filler of desired size, and the like) also may be included to control bond line thickness.

A particularly useful composition for use in the present invention includes: (i) a first part including (a) at least one (meth)acrylate component in an amount that is from about 30% by weight to about 95% by weight of the first part; (b) at least one elastomeric polymer in an amount that is from about 10% by weight to about 30% by weight of the first part; and (c) at least one organic acid component in an amount that is from about 1% by weight to about 5% by weight of the first part; and (ii) a second part including (a) at least one (meth)acrylate component in an amount that is from about 60% by weight to about 99% by weight of the second part; (b) at least one component that functions as a corrosion inhibitor and/or UV stabilizer in an amount that is from about 10% by weight to about 30% by weight of the second pail; and (c) at least one accelerator component in an amount that is from about 1% by weight to about 5% by weight of the second part. The first part of such a composition optionally may include at least one polymer stabilizer in an amount that is from about 1% by weight to about 5% by weight of the first part. Additionally, or in the alternative, the first part also may optionally include at least one antioxidant that also may function as a stabilizer in an amount that is from about 1% by weight to about 5% by weight of the first part and/or at least one filler in an amount that is from about 0.1% by weight to about 2% by weight of the first part. Desirably, in some embodiments, the first part includes at least two fillers which are each present in an amount that is from about 0.1% by weight to about 1% by weight of the first part.

Another particularly useful composition for use in the present invention includes: (i) a first part including (a) at least two (meth)acrylate components in a total amount that is from about 40% by weight to about 90% by weight of the first part; (b) at least one elastomeric polymer in an amount that is from about 10% by weight to about 30% by weight of the first part; and (c) at least one organic acid component in an amount that is from about 1% by weight to about 5% by weight of the first part; and (ii) a second part including (a) at least one (meth)acrylate component in an amount that is from about 60% by weight to about 99% by weight of the second part; (b) at least one component that functions as a corrosion inhibitor and/or UV stabilizer in an amount that is from about 10% by weight to about 30% by weight of the second part; and (c) at least one accelerator component in an amount that is from about 1% by weight to about 5% by weight of the second part. The first part of such a composition optionally may include at least one polymer stabilizer in an amount that is from about 1% by weight to about 5% by weight of the first part. Additionally, or in the alternative, the first part also may optionally include at least one antioxidant that also may function as a stabilizer in an amount that is from about 1% by weight to about 5% by weight of the first pail and/or at least one filler in an amount that is from about 0.1% by weight to about 2% by weight of the first part. Desirably, in some embodiments, the first part includes at least two fillers which are each present in an amount that is from about 0.1% by weight to about 1% by weight of the first part.

Yet another particularly useful composition for use in accordance with the present invention includes (i) a first part including: (a) at least one (meth)acrylate component that is present in an amount that is from about 30% by weight to about 60% by weight of the first part; (b) at least one (meth)acrylate component that is present in an amount that is from about 10% by weight to about 30% by weight of the first part; (e) at least one elastomeric polymer in an amount that is from about 10% by weight to about 30% by weight of the first part; and (d) at least one organic acid component in an amount that is from about 1% by weight to about 5% by weight of the first part; and (ii) a second part including (a) at least one (meth)acrylate component in an amount that is from about 60% by weight to about 99% by weight of the second part; (b) at least one component that functions as a corrosion inhibitor and/or UV stabilizer in an amount that is from about 10% by weight to about 30% by weight of the second part; and (e) at least one accelerator component in an amount that is from about 1% by weight to about 5% by weight of the second part. The first part of such a composition optionally may include at least one polymer stabilizer in an amount that is from about 1% by weight to about 5% by weight of the first part. Additionally, or in the alternative, the first part also may optionally include at least one antioxidant that also may function as a stabilizer in an amount that is from about 1% by weight to about 5% by weight of the first part and/or at least one filler in an amount from about 0.1% by weight to about 2% by weight of the first part. Desirably, in some embodiments, the first part includes at least two fillers which are each present in an amount that is from about 0.1% by weight to about 1% by weight of the first part.

The compositions of the present invention may be applied to any suitable substrate in accordance with the present inventive method and process. It is especially useful to apply a composition of the present invention to surfaces that are known to be difficult to bond together, such as fluorocarbon-coated surfaces and, more particularly, polyvinylidene fluoride-coated surfaces. For example, it is useful to apply a composition of the present invention to galvanized surfaces that are at least partially coated with polyvinylidene fluoride.

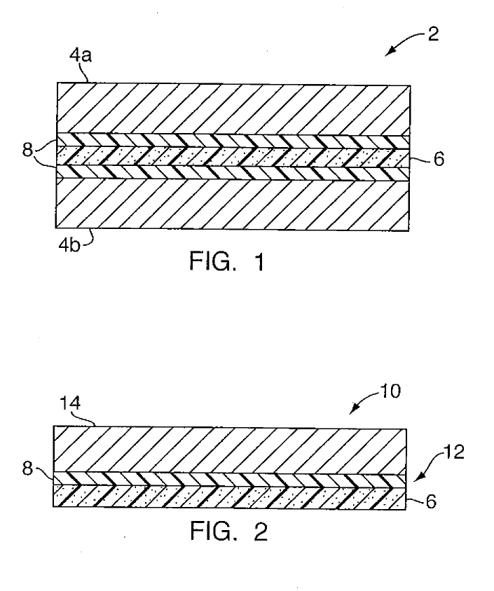

The present invention will be further understood by reference to FIGS. 1-2. FIG. 1 illustrates an article of manufacture 2 including two substrate surfaces 4a and 4h bonded together with a composition 6 of the present invention. As shown in FIG. 1, the substrate surfaces 4a and 4b, which may be any suitable substrate surface, such as a galvanized surface, are coated with a polyvinylidene fluoride-containing coating 8. The composition 6 is a two-part composition, which includes a first part which desirably includes methyl methacrylate, a polyethylene-based rubber, a hydroxyalkyl methacrylate, an organic acid, a methacrylate ester, a polymer stabilizer, an antioxidant that also may function as a stabilizer, and at least one filler. The second part of composition 6 desirably includes methyl methacrylate, a corrosion inhibitor that also may function as a UV stabilizer, and an accelerator.

FIG. 2 illustrates an assembly 10 of the present invention. The assembly 10 includes an adhesive system 12 that includes at least one substrate 14 that is coated with a polyvinylidene fluoride-containing coating 8. The adhesive system 12 also includes a composition 6 of the present invention. The composition 6 is a two-part composition which includes a first part which desirably includes methyl methacrylate, a polyethylene-based lubber, a hydroxyalkyl methacrylate, an organic acid, a methacrylate ester, a polymer stabilizer, an antioxidant that may function as a stabilizer, and at least one filler. The second part of the composition 6 desirably includes methyl methacrylate, a corrosion inhibitor that also may function as a UV stabilizer, and an accelerator. The assembly 10 may be, for example, a construction assembly or a steel construction assembly. When the assembly 10 is a construction assembly, the substrate 14 may be any material that may be used in the same, such as steel. When the assembly 10 is a roofing assembly, the substrate 14 may be any material that may be used in the same, such as, for example, roofing panels.

As illustrated in the examples set forth below, the compositions of the present invention unexpectedly demonstrate superior bond strength on polyvinylidene fluoride coated surfaces.

### EXAMPLES

Table I below illustrates an adhesive composition for use in the present inventive processes, methods, assemblies, and articles of manufacture.

TABLE 1

| | Wt. % |
|---|---|
| Components - Part A | |
| methyl methacrylate | 30-60 |
| polyethylene-based rubber | 10-30 |
| hydroxyalkyl methacrylate | 10-30 |
| organic acid¹ | 1-5 |
| methacrylate ester | 1-5 |
| polymer stabilizer² | 1-5 |
| antioxidant/stabilizer³ | 1-5 |
| filler⁴ | 0.1-1 |
| filler⁵ | 0.1-1 |
| TOTAL | 100 |
| Components - Part B | |
| methyl methacrylate | 60-99% |
| corrosion inhibitor/UV stabilizer⁶ | 10-30 |
| accelerator⁷ | 1-5 |
| TOTAL | 100 |

¹Methacrylic acid
²2,6-Di-t-butyl-p-cresol
³4-Methoxyphenol
⁴Talc
⁵Soda lime borosilicate glass
⁶Boric acid, barium salt
⁷Aldehyde-amine condensate

### Example 1

This example demonstrates the ability of compositions of the invention to withstand extremely high tensile loads on galvalume substrates.

A two-part composition was prepared in accordance with Table 1. The composition contained Parts A and B in a 2:1 ratio. Three lap shear specimens were then prepared using the composition on galvalume substrates. The specimens were 25 gauge (0.019″) 5″ long by 1½″ wide strips having a 2.25″ by 2.25″ overlap.

The specimens were cured for seventy-two hours at room temperature. The specimens were pulled in tensile shear mode using an Instron Mechanical Properties Tester in accordance with American Standard Test Measurement (ASTM) D 1002. The specimens were pulled under a load at a rate of 0.5 inches/minute. The results of the aforementioned measurements are shown in Table 2.

TABLE 2

| Specimen | Load | Result |
|---|---|---|
| 1 | 2377 lbs | metal elongated but bond |
| | | did not fail |
| 2 | 2400 lbs | metal elongated but bond |
| | | did not fail |
| 3 | 2387 lbs | metal elongated but bond |
| | | did not fail |

As is apparent from Table 2, the adhesive bond on all of the tested specimens did not fail, even when subjected to loads that caused the Galvalume metal substrate to elongate. Specifically, specimen #1 withstood a load of 2377 lbs, while specimens #2 and #3 withstood loads of 2400 lbs and 2387 lbs, respectively.

### Example 2

This example demonstrates the superior ability of the composition of the invention to bond to polyvinylidene fluoride-coated substrates.

A two-part composition was prepared in accordance with Table 1. The composition contained Parts A and B in a 2:1 ratio. Four lap shear specimens were then prepared. In particular, for each specimen, the composition was used to bond a galvalume substrate to a metal substrate that was coated with KYNAR® polyvinylidene fluoride. The specimens were 25 gauge (0.019″) 5″ long by 1½″ wide strips having a 2.25″ by 2.25″ overlap.

The specimens were cured for seventy-two hours at room temperature. The specimens were pulled using an Instron testing machine in accordance with American Standard Test Measurement (ASTM) D1002. The specimens were pulled under a load at a rate of 0.5 inches/minute. The results of the aforementioned measurements are shown in Table 3.

TABLE 3

| Specimen | Load | Result |
|---|---|---|
| 1 | 1943 lbs | metal elongated/Kynar was pulled |
| | | off of galvalume substrate |
| 2 | 2259 lbs | metal elongated/Kynar was pulled |
| | | off of galvalume substrate |
| 3 | 2168 lbs | metal elongated/Kynar was pulled |
| | | off of galvalume substrate |
| 4 | 2186 lbs | metal elongated/Kynar was pulled |
| | | off of galvalume substrate |

As is apparent from Table 3, the adhesive bond between the galvalume and KYNAR® polyvinylidene fluoride did not fail for all of the specimens at very high loads. Significantly, as is apparent from Table 3, the adhesive bond between the galvalume and KYNAR® polyvinylidene fluoride did not break even when subjected to very high loads that caused the metal to elongate. In fact, the bond between the adhesive composition and the KYNAR® polyvinylidene fluoride was so strong for all specimens that the adhesive composition pulled the KYNAR® polyvinylidene fluoride off of the galvalume substrate. In particular, with regard to specimen #2, the adhesive bond between the galvalume substrate and the polyvinylidene fluoride surface did not break even when subjected to a load of 2259 lbs.

Although the examples exemplify the use of the two-part composition set forth in Table 1 where Parts A and B are present in a 2:1 ratio; it should be understood that Parts A and B may be present in any suitable ratio, such as, for example, 2.1:1.9. In some embodiments, there may be, for example, a 15-20% variation from the 2:1 ratio.

The examples set forth above serve to illustrate the present invention, but in no way are intended to limit the spirit and scope thereof, which is defined by the following claims.

What is claimed is:

1. A method for bonding together two substrates, comprising the steps of:
(a) applying to a first substrate surface a composition comprising:
(i) at least one curable (meth)acrylate component;
(ii) at least one elastomeric polymer that is soluble in the (meth)acrylate component; and
(iii) an organic acid component;
(b) mating the surface of a second substrate in abutting relationship with composition-applied first substrate surface to form an assembly; and
(c) maintaining the abutting relationship for a time sufficient to allow the composition to cure, wherein at least one of the abutting substrate surfaces is at least partially coated with a fluorocarbon-containing coating, and wherein an adhesive bond is formed between the composition and the fluorocarbon-containing coating.

2. The method of claim 1, wherein the (meth)acrylate component is present in an amount from about 30% to about 60% by weight of the composition.

3. The method of claim 1, wherein the elastomeric polymer is present in an amount from about 10% to about 30% by weight of the composition.

4. The method of claim 1, wherein the organic acid component is present in an amount from about 1% to about 5% by weight of the composition.

5. The method of claim 1, wherein at least one of the substrate surfaces is galvanized.

6. The method of claim 1, wherein both of the substrate surfaces are galvanized.

7. The method of claim 1, wherein both of the substrate surfaces are at least partially coated with the fluorocarbon-containing coating.

8. The method of claim 1, wherein at least one of the substrates surfaces is completely coated with the fluorocarbon-containing coating.

9. The method of claim 1, wherein both of the substrate surfaces are completely coated with the fluorocarbon-containing coating.

10. The method of claim 1, wherein the composition exhibits a tensile strength of at least about 2200 lbs on the fluorocarbon-coated substrate surface.

11. The method of claim 1, wherein the fluorocarbon-containing coating is a polyvinylidene fluoride-containing coating.

12. A process for improving adhesion to a substrate surface comprising a fluorocarbon-containing coating, comprising the steps of:
1.) applying to a surface comprising a fluorocarbon-containing coating an adhesive composition, wherein the composition comprises:
(i) at least one curable (meth)acrylate component;
(ii) at least one elastomeric polymer that is soluble in the (meth)acrylate f component; and
(iii) an organic acid component; and
2. subjecting the composition-applied substrate surface to conditions sufficient to allow the composition to cure, wherein an adhesive bond is formed between the composition and the fluorocarbon-containing coating.

13. The process of claim 12, wherein the surface is galvanized.

14. The process of claim 13, wherein the surface is at least partially coated with the fluorocarbon-containing coating.

15. The process of claim 12, wherein the fluorocarbon-containing coating is a polyvinylidene fluoride-containing coating.

16. An article of manufacture comprising at least two substrate surfaces bonded together by means of the method of claim 1.

17. An assembly comprising:
(a) an adhesive system comprising a composition comprising:
(i) at least one curable (meth)acrylate component;
(ii) at least one elastomeric polymer that is soluble in the (meth)acrylate component; and
(iii) an organic acid component; and
(b) at least one substrate surface comprising a polyvinylidene fluoride-containing coating, wherein the composition bonds to the polyvinylidene fluoride-containing coating.

18. The assembly of claim 17, wherein the assembly is a roofing assembly.

19. The assembly of claim 17, wherein the assembly is a steel construction assembly.

20. A composition for bonding two substrates comprising:
(a) a first part comprising:
(i) at least one alkyl (meth)acrylate;
(ii) a polyethylene-based rubber; and
(iii) at least one hydroxyalkyl (meth)acrylate; and
(b) a second part comprising:
(i) at least one alkyl (meth)acrylate; and
(ii) an accelerator.
